(19) United States
(12) Patent Application Publication
(10) Pub. No.: US 2009/0071348 A1
(43) Pub. Date: Mar. 19, 2009

(54) Rotisserie utensil for remotely orienting food in relation to a heat source

(76) Inventor: Peter B. Burns, Winnetka, CA (US)

Correspondence Address: Elliott N. Kramsky, Suite 400, 5850 Canoga Avenue, Woodland Hills, CA, 91367, US

(21) Appl. No.: 12/148,227

(22) Filed: Apr. 18, 2008

Related U.S. Application Data
(60) Provisional application No. 60/973,108, filed on Sep. 17, 2007.

(51) Int. Cl. A47J 37/04

(52) U.S. Cl. 99/421 R

(57) ABSTRACT

A rotisserie utensil for roasting food over an open flame or other heat source. The utensil includes a pair of elongated handles. The distal end of each handle is formed into a tunnel for receiving a segment of a crank that includes an offset segment. One end of the crank comprises a loop and the opposed end of the crank comprises a pair of tines for rotatably securing the utensil and for impaling food for rotation about an axis that is substantially orthogonal to the elongated handles.

### REFERENCE TO RELATED APPLICATION

The present application claims the priority of provisional patent application Ser. No. 60/973,108 of inventor Peter B. Burns “Rotary Marshmallow Roaster” filed Sep. 17, 2007 in the United States Patent and Trademark Office.

### BACKGROUND

1. Field of the Invention

The present invention relates to rotisserie utensils for cooking food over coals, open flame or other source of heat. More particularly, this invention pertains to an elongated utensil comprising two arms for remotely rotating food about an axis that is substantially orthogonal to the elongated arms.

2. Description of the Prior Art

Roasting of food (e.g. over a campfire) is a staple of any camping experience. Unfortunately, the quality of the cooked food is often poor, due in part to the limited skill and experience of the cook but more often due to the primitive nature of the utensils employed.

Cooking food over a campfire usually requires the remote insertion of the food, such as marshmallows, meat, or vegetables, into, preferably indirect contact with coals or other heat source. Such cooking is not only enjoyable but may also enhance the taste of the cooked food. Typically, an elongated utensil, capable of holding the food at a remote end, is employed. The cook grasps the utensil at its proximate end so that his hand is safely removed from the heat source.

Numerous devices have been developed to facilitate the campfire cooking experience. Often, such devices provide improvements directed to the retention and remote manipulation of the food as it is cooked. Such remote manipulation commonly includes the capability of rotating the food about an axis as it is exposed to the heat to assure that the food is cooked evenly. Devices of this type are disclosed, for example, in the following United States patents: U.S. Pat. No. 2,876,694 of G. W. Thomas for “Marshmallow and Hot Dog Roasting Stick”; U.S. Pat. No. 3,742,840 of James M. Cogswell for “Rotary Fork”; U.S. Pat. Nos. 5,238,455 and 5,310,381 of Ronald Green for “Campfire Skewer”; U.S. Pat. No. 7,219,936 of Martin James Willford for “Campfire Rotisserie”; and U.S. Pat. No. 7,234,392 of Darren John Arndt for “Open Flame Rotisserie Utensil Having Spiral Wiener Receptacle”.

Such devices generally include relatively-complex mechanisms for causing the food to rotate as it is being cooked. Typically, a rotatable element, such as a handle or portion of a handle, is arranged to be turned at the proximal end of an elongated utensil to cause tines at the distal end to rotate correspondingly in the manner of a rotisserie. The tines are more-or-less aligned with the axis of the elongated utensil so that the food rotates about an axis extending from the user and into the open flame. As a result, the remote end of the food impaled on the tines remains closer to the heat source than the proximal end. This can result in overcooking of the remote portion and undercooking of the proximal portion of the food as it is roasted despite the rotisserie action of the tines.

### SUMMARY OF THE INVENTION

The present invention addresses shortcomings of the prior art by providing a utensil which orients and rotates food more efficiently in relation to a heat source. Such utensil includes a main handle and a crank handle, each handle having opposed proximal and distal ends. A crank is provided comprising first and second substantially straight segments that are substantially parallel to one another.

The first and second substantially straight segments are joined to one another by an offset segment. The distal end of the main handle comprises a first transverse chamber for rotatably receiving the first substantially straight segment and the distal end of the crank handle comprises a second transverse chamber for rotatably receiving the second substantially straight segment.

A pair of tines is provided, each of which is fixed and substantially parallel to the first segment and a loop is fixed to the second segment for rotatably securing the crank to the crank handle.

The preceding and other features of the invention are described in a detailed description that follows. Such description is accompanied by a set of drawing figures. Numerals of the drawing figures, corresponding to those of the written description, point to the features of the invention. Like numerals refer to like features throughout both the written description and the drawings.

### BRIEF DESCRIPTION OF THE DRAWINGS

FIG. 1 is a side elevation view of a utensil in accordance with the invention;

FIG. 2 is a partial side sectional view of the utensil; and

FIGS. 3(a) through 3(d) are a series of views for illustrating the manner operation of the utensil of the present invention.

### DETAILED DESCRIPTION OF THE PREFERRED EMBODIMENT

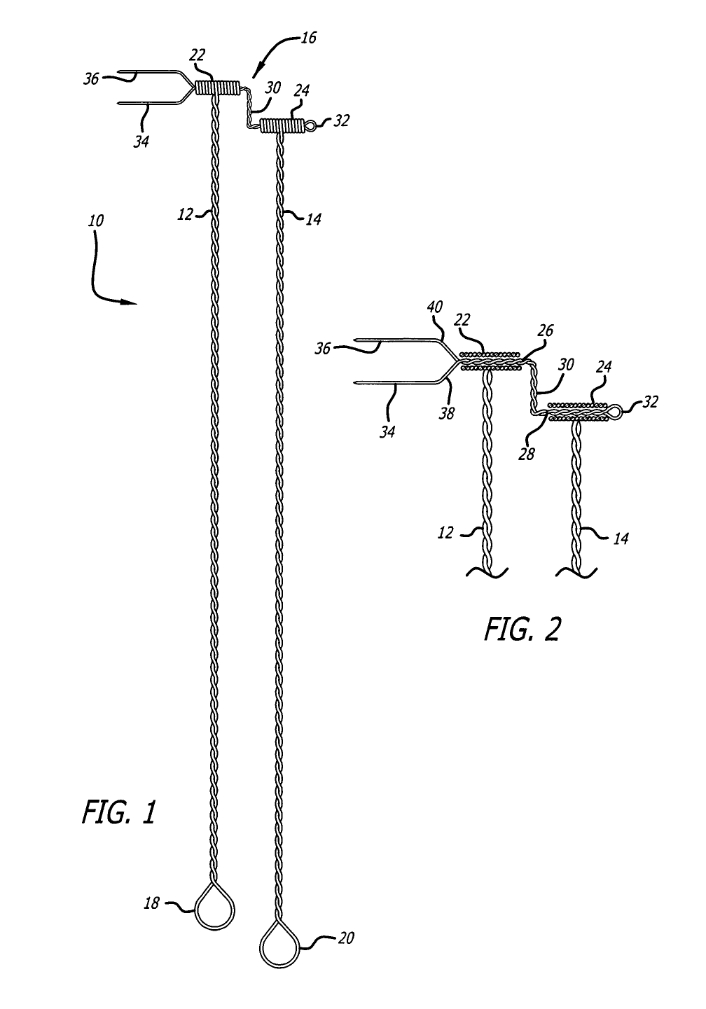

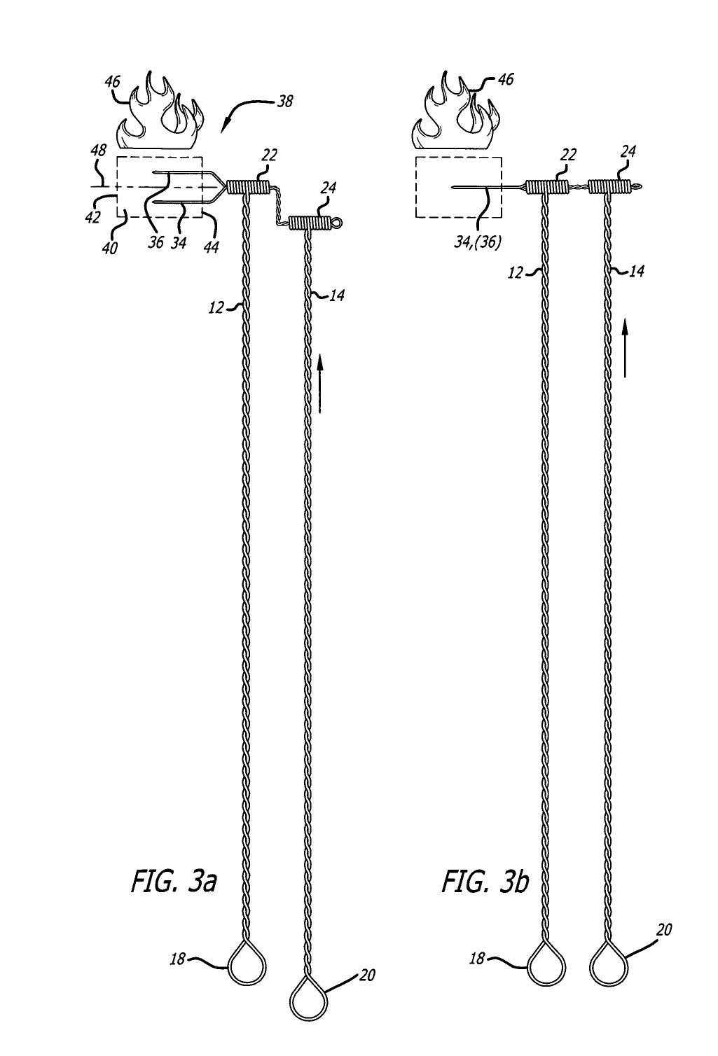

Turning now to the drawings, FIG. 1 is a side elevation view of a utensil 10 in accordance with the invention and FIG. 2 is a partial side sectional view thereof.

Viewing FIGS. 1 and 2, the utensil 10 comprises a main handle 12 and a crank handle 14 joined to one another by a crank 16. Each of the handles 12, 14 is formed of a piece of wire that has been preferentially wound to form a proximate end loop 18, 20 and a distal end tunnel 22, 24 respectively.

The tunnels 22 and 24 are provided for rotatably receiving the crank 16. Such crank 16 is also formed of a preferentially wound wire and includes first and second segments 26 and 28 that mutually adjoin and are integral with an offset segment 30. A loop 32 formed at the end of the second segment 28 acts as a stop for securing the utensil assembly together while a parallel pair of tines 34, 36, comprising the opposed ends of the wire from which the crank 16 is formed, are positioned adjacent the free end of the first segment 26 by angularly-flared wire sections 38, 40.

As can be seen, the tunnels 22 and 24 at the distal ends of the handles 12 and 14 respectively house the segments 26 and 28 rotatably therein whereby the tunnel 24, under force applied at the proximal end of the crank handle 14, can cause the offset segment 30 (and attached tines 34, 36) to rotate with respect to the tunnel 22.

As mentioned above, each of the handles 12 and 14 and the crank 16 is formed of wound wire. Various materials and sizes of wire may be utilized to form the elements of the utensil 10, in each case affecting the properties of the resulting structures. Further, the number of windings of such wire may be varied to produce elements of differing characteristics.

Either stainless steel or plated steel wire may be utilized for both heat resistance and food safety. In a preferred embodiment, food grade, non-corrosive 18-8 stainless steel was employed for both the handles and the crank of the utensil. Such material is a more “bendable” (and therefore easier to fabricate) version of 300 series stainless steel. The handles 12, 14 were formed of wire whose gauge is United States Standard 12 while wire whose gauge is United States Standard 14 was employed for the crank 16 to assure desired stiffness with minimal thickness of the tines 34, 36, resulting in minimal resistance when impaling food. (Wire thickness is inversely proportional to gauge number.) A twist rate of 2.5 per inch provided sufficient rigidity and an attractive appearance for both the handles 12, 14 and the crank 16.

Generally, in use, the tunnel 22 at the distal end of the handle 12 is maintained at rest while the tunnel 24 at the distal end of the handle 14 is rotated to cause the tines 34, 36 (and the food thereon) to rotate with respect to an open flame or other heat source. To assist the stabilizing role of the tunnel 22 vis a vis the tunnel 24, the length of the tunnel 22 may exceed that of the tunnel 24. In an actual embodiment of the invention, the tunnel 22 comprised a total of 14 turns of wire (7 turns to either side of the elongated main handle 12) while the tunnel 24 comprised 10 turns (5 turns to either side of the elongated crank handle 14).

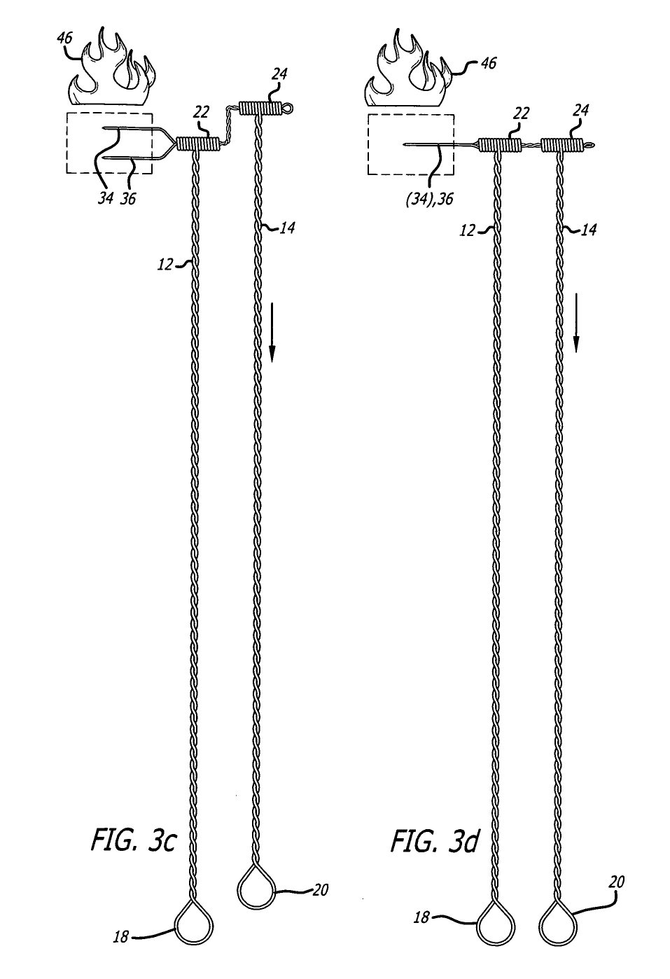

FIGS. 3(a) through 3(d) are a series of views for illustrating the manner operation of the utensil of the present invention through a 360 degree rotation of the tines 34, 36. A marshmallow 38 having curved surface 40 and opposed, generally planar, end surfaces 42, 44 is shown in shadow outline impaled and held by the pair of tines 34, 36 throughout the figures. Due to the symmetry of the generally-cylindrical marshmallow 38, the rotation thereof with the tines is not apparent in these views. However, the rotation of the tines 34, 36, which carries and rotates the marshmallow 38, will be clearly appreciated.

In operation, a user (not shown) grasps the handles 12, 14 of the utensil from the bottom of each of FIGS. 3(a) through 3(d) and manipulates them to cook the marshmallow 38 over a remote heat source 46 that appears at the top of each of the figures. As can be seen, rotisserie cooking in which the curved surface 40 of the marshmallow 38 is rotated with respect to the fire 46 while the positions of the opposed end surfaces 42, 44 although rotating within their reference planes, remain within spaced-apart planes that are approximately equidistant (spaced only by the height of the curved surface 40) from the remote heat source 46.

Rotisserie cooking is accomplished by a user while holding the bottom of the main handle 12 adjacent the loop 18 (with his left hand in accordance the orientation of FIGS. 3(a) through 3(d), although the opposite orientation is equally possible) and the bottom of the crank handle 14 adjacent the loop 20 with his right hand. The utensil 10, operated as described below, enables such user to remotely rotate the marshmallow 38 or other food, to cook it over the fire 46.

Holding the utensil 10 as described above, the user preferably maintains the position of the main handle 12 while moving the arm 14 up (FIGS. 3(a) through 3(c)) and down (FIG. 3(d)) when viewed in the referenced figures. Such movement of the crank handle 14 is produced by pushing or pulling it, presumably at the proximal loop 20 or close thereto to protect the user's hand from the heat source 46. Such pushing/pulling motion is translated into alternating lifting and pushing down of the distal end of the elongated crank handle 14 (and the tunnel 24) by the offset section 30 of the crank 16 which pivots about the stable position of the tunnel 22 at the distal end of the other handle 12. This makes the distal end of the crank handle 14 rotate within the tunnel 24, causing the entire crank 16 to rotate. Such rotation of the crank 16 results in rotation of the tines 34, 36 about an axis 48 that is orthogonal to the length of the elongated main handle 12 to produce the motion observed in the series of FIGS. 3(a) through 3(d).

By providing a utensil that enables rotisserie cooking in which the food is held and rotated about an axis that is transverse or orthogonal to the lengths of the handles 12, 14 that a user employs to permit manipulation remote from an open fire 46, an advantageous roasting method is enabled. Such roasting method assures that the food impaled upon the tines 34, 36 remains horizontally oriented regardless of the orientation of the elongated arms 12, 14. This is advantageous in the case of marshmallow, hot dog and other meat and vegetable roasting as food is frequently subject to falling off conventional utensils in which the food is mounted in alignment with an elongated handle.

Rotation of the food about a transverse axis permits one to control the browning of the major curved surface 40 of a marshmallow at the same time the opposed ends 42, 44 are cooked evenly as the rotate generally within planes that are evenly spaced from the common remote fire 46. (Although some food is not of generally-cylindrical shape, such food is also advantageously uniformly roasted with a utensil in accordance.) This is in contrast to conventional devices that routinely rotate along the axis of an elongated handle so that one end of the food is continually statically closer to the fire than the opposed end.

In addition to offering an improved device that permits an advantageous roasting method, the utensil of the invention is of simplified design and manufacture, formed of three pieces of wire. As a result, the utensil is economical, permitting one to purchase a number thereof, each being suited to the roasting of food of particular size and shape. Different models of the utensil may feature, for example, relatively short and widely-spaced pairs of tines for holding and roasting marshmallows while more narrowly-spaced and longer pairs of tines may be more suitable for roasting weiners.

Thus, it is seen that the present invention provides a rotisserie utensil for preferentially orienting food with respect to an open flame or other source of heat as it is cooked or roasted. By employing the teachings of the invention, a user obtains the full benefit of the rotisserie action insofar as the ends of a piece of food impaled on the tines of the utensil are cooked to approximately equal extents at the same time the body of the food that lies between the ends is rotated for even cooking. The geometries of such generally-cylindrical foods as wieners and marshmallows, favorites of campfire cookouts, are particularly suitable for realizing the benefits of the rotisserie utensil of the invention.

While this invention has been described with reference to its presently preferred embodiment, it is not limited thereto. Rather, the invention is limited only insofar as it is defined by the following set of patent claims and includes within its scope all equivalents thereof.

What is claimed is:

1. A utensil for preferentially rotating food in relation to a heat source comprising, in combination:
a) an elongated main handle having opposed proximal and distal ends;
b) an elongated crank handle having opposed proximal and distal ends;
c) a crank, said crank comprising a first substantially straight segment and a second substantially straight segment, said first and second substantially straight segments being substantially parallel to one another;
d) said first and second substantially straight segments being joined to one another by an offset segment;
e) said distal end of said main handle comprising a first transverse tunnel for rotatably receiving said first substantially straight segment;
f) said distal end of said crank handle comprising a second transverse tunnel for rotatably receiving said second substantially straight segment;
g) a pair of tines, each of said tines being fixed and substantially parallel to said first segment; and
h) a loop being fixed to said second segment for rotatably securing said crank to said crank handle.

2. A utensil as defined in claim 1 wherein said crank comprises an integral apparatus.

3. A utensil as defined in claim 2 wherein each of said elongated handles comprises a single wire.

4. A utensil as defined in claim 1 wherein said crank comprises a single wire.

5. A utensil as defined in claim 4 wherein:
a) said main handle comprises a wire having multiple turns defining said first transverse tunnel at said distal end and a loop at a proximal end; and
b) said crank handle comprises a wire having multiple turns defining said second transverse tunnel at said distal end and a loop at a proximal end.

6. A utensil as defined in claim 5 wherein each of said first and second straight segments and said offset segment of said crank comprises a plurality of wire windings.

7. A utensil as defined in claim 6 wherein said first and second tunnels are of different lengths.

8. A utensil as defined in claim 7 wherein said first transverse tunnel is longer than said second transverse tunnel.

9. A utensil as defined in claim 8 wherein:
a) said first transverse tunnel comprises 14 turns of said wire comprising said main handle; and
b) said second transverse tunnel comprises 10 turns of said wire comprising said crank handle.
